(19) United States
(12) Patent Application Publication
(10) Pub. No.: US 2017/0041486 A1
(43) Pub. Date: Feb. 9, 2017

(54) IMAGE FORMING APPARATUS, IMAGE FORMING SYSTEM, AND IMAGE FORMING METHOD

(71) Applicants: Yuichi Noda, Kanagawa (JP); Hidenori Shindoh, Tokyo (JP)

(72) Inventors: Yuichi Noda, Kanagawa (JP); Hidenori Shindoh, Tokyo (JP)

(73) Assignee: Ricoh Company, Ltd., Tokyo (JP)

(21) Appl. No.: 15/227,660

(22) Filed: Aug. 3, 2016

(30) Foreign Application Priority Data
Aug. 5, 2015 (JP) 2015155236

(51) Int. Cl. H04N 1/00; H04N 1/23; H04N 1/21

(52) U.S. Cl. CPC H04N 1/00931; H04N 1/2104; H04N 1/00814; H04N 1/2346; H04N 2201/0094

(57) ABSTRACT

An image forming apparatus includes: a reading device configured to read a document; a primary storage device configured to temporarily store therein image data of the read document; a printing device configured to print the temporarily-stored image data; and a control device configured to set a printing speed and to synchronize a reading speed of the reading device with the printing speed of the printing device so that a waiting time is minimized.

### CROSS-REFERENCE TO RELATED APPLICATIONS

The present application claims priority under 35 U.S.C. §119 to Japanese Patent Application No. 2015-155236, filed Aug. 5, 2015. The contents of which are incorporated herein by reference in their entirety.

### BACKGROUND OF THE INVENTION

1. Field of the Invention

The present invention relates to an image forming apparatus, an image forming system, and an image forming method.

2. Description of the Related Art

In an image forming apparatus, generally, after a scanned document has been stored in a primary storage device, the document is saved to a secondary storage device. There has been developed and already known a technology to process an input image and an output image separately to achieve the processing with low memory consumption.

However, such a conventional image forming apparatus has a problem that it takes time to save images to the secondary storage device after the images have been stored in the primary storage device, which causes a drop in printing speed performance in the printing of a multi-page document as compared with in the printing of a one-page document.

Therefore, various suggestions have been made (for example, see Patent Literature 1: Japanese Unexamined Patent Application Publication No. 2013-115458). Patent Literature 1 has disclosed a technology that allows for input/output timing adjustment on the software side with the aim of processing multi-color and large-volume image data with low memory consumption.

However, the technology disclosed in Patent Literature 1 has not solved the problem that it takes time for the image forming apparatus to save images to the secondary storage device after the images have been stored in the primary storage device, which causes a drop in printing speed performance in the printing of a multi-page document.

### SUMMARY OF THE INVENTION

According to an aspect of the present invention, there is provided an image forming apparatus including: a reading device configured to read a document; a primary storage device configured to temporarily store therein image data of the read document; a printing device configured to print the temporarily-stored image data; and a control device configured to set a printing speed and to synchronize a reading speed of the reading device with the printing speed of the printing device so that a waiting time is minimized.

According to another aspect of the present invention, there is provided an image forming system including: a document reader configured to read a document; a memory configured to temporarily store therein image data of the read document; a printer configured to print the temporarily-stored image data; and a controller configured to set a printing speed and to synchronize a reading speed of the reading device with the printing speed of the printing device so that a waiting time is minimized.

According to still another aspect of the present invention, there is provided an image forming method including: setting a printing speed when image data of a read document is temporarily stored and then printed; and synchronizing a reading speed of a reading device with the printing speed of a printing device so that a waiting time is minimized.

### BRIEF DESCRIPTION OF THE DRAWINGS

FIG. 1 is an entire configuration diagram of an image forming apparatus according to an embodiment;

FIG. 2 is a software configuration diagram of the image forming apparatus shown in FIG. 1;

FIG. 3 is an explanatory diagram explaining about a request for printing in high-speed mode determined as printing mode in a process performed by controller software and engine software of the concrete image forming apparatus;

FIG. 4 is an explanatory diagram explaining about a request for printing in normal mode determined as printing mode in a process performed by the controller software and the engine software of the concrete image forming apparatus;

FIG. 5 is an explanatory diagram explaining about a request for printing in the normal mode determined as printing mode in a process performed by the controller software and the engine software of the concrete image forming apparatus;

FIG. 6 is an explanatory diagram explaining about an operating time of each resource in a printing operation using only a primary storage device without using a secondary storage device in synchronization with the input/output timing as this system of the concrete image forming apparatus;

FIG. 7 is an explanatory diagram explaining about an operating time of each resource in a printing operation in which data is stored in an HDD in synchronization with the input/output timing of the concrete image forming apparatus;

FIG. 8 is an explanatory diagram explaining about an operating time of each resource in a printing operation using only the primary storage device without the synchronization with the input/output timing of the concrete image forming apparatus; and

FIG. 9 is an explanatory diagram explaining about an operating time of each resource in a printing operation using both the primary storage device and the secondary storage device without the synchronization with the input/output timing of the concrete image forming apparatus.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and the are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

The present invention has an object to provide an image forming apparatus, an image forming system, and an image forming method capable of achieving high printing speed with low memory consumption even in the printing of a multi-page document.

### Outline

An exemplary embodiment of an image forming apparatus according to the present invention is described below. The image forming apparatus according to the present embodiment has the following characteristics in input/output control and printing speed performance. In short, when a conventional image forming apparatus prints a large number of images, it takes time to save the images from a primary storage device to a secondary storage device. On the other hand, the image forming apparatus according to the present embodiment synchronizes the reading speed of a scanner with the printing speed of a plotter, and therefore can constantly output an image from a primary storage device directly to the plotter without saving the image to a secondary storage device. The above-mentioned characteristics of the image forming apparatus according to the embodiment are explained in detail below with reference to accompanying drawings.

### Embodiment

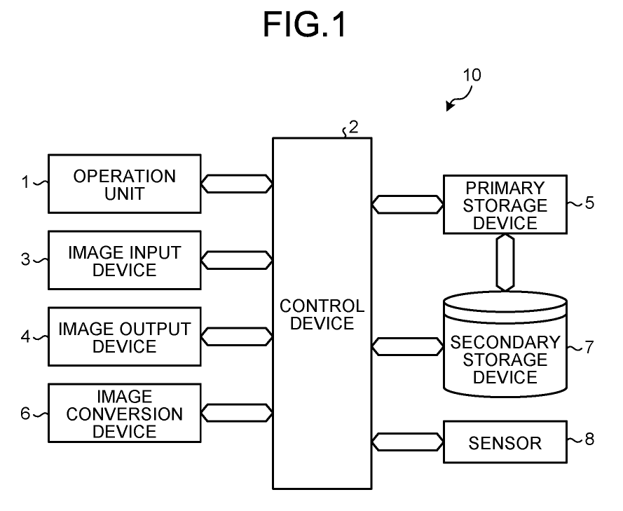

FIG. 1 is an entire configuration diagram of the image forming apparatus according to the embodiment. An image forming apparatus 10 includes an operation unit 1, a control device 2, an image input device 3, an image output device 4, a primary storage device 5, an image conversion device 6, and a secondary storage device 7.

The operation unit 1 shown in FIG. 1 is a touch-panel device that displays thereon a screen for operation and performs controlled input/output. The control device 2 is a device that performs a requirement for control on each device. The image input device 3 is a device that performs an input of an image. The image output device 4 is a device that performs an output of an image. The primary storage device 5 is a device that temporarily stores therein a memory for image processing or processing control. The image conversion device 6 is a device that converts an image into a display image, and is a function of displaying an image on a display unit. The secondary storage device 7 is a device used to retain an image or setting-related information. A sensor 8 is a sensor that detects the reading speed and the printing speed.

The control device 2, the image input device 3, and the image output device 4 correspond to a means to fix the reading speed and the printing speed in combination with a controller unit and an engine unit, a means to set the reading speed and the printing speed on a page-by-page basis by reading control/printing control, and a means to set the reading speed and the printing speed on a page-by-page basis based on the reading speed and printing speed measured by a reading-speed/printing-speed sensor. A means to lock a setting button so as to be kept unchanged means to lock software.

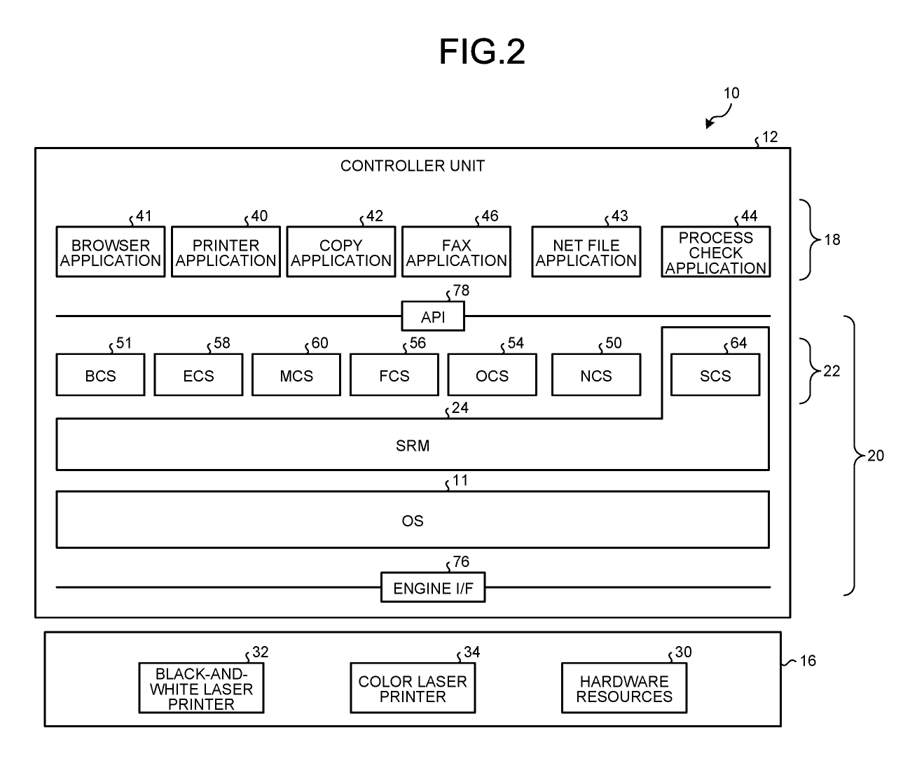

FIG. 2 is a software configuration diagram of the image forming apparatus shown in FIG. 1. The image forming apparatus 10 shown in FIG. 2 is composed of a controller unit 12 and a hardware unit 16; the controller unit 12 includes various software components, and the hardware unit 16 includes various hardware resources.

The hardware unit 16 includes a black-and-white laser printer 32, a color laser printer 34, and other hardware resources 30 such as a scanner and a facsimile device. The controller unit 12 includes an application layer 18 and a platform layer 20; the application layer 18 includes various applications 40 to 44 and 46.

The application layer 18 performs a user service-specific process related to image processing by a printer, a copier, a fax, a scanner, etc. In the embodiment shown in FIG. 2, the application layer 18 includes a printer application 40, a copy application 42, a fax application 46, and a scanner application 48. The printer application 40 provides a printer function; the copy application 42 provides a copy function; the fax application 46 provides a fax function, and the scanner application 48 provides a scanner function.

The platform layer 20 includes a control service layer 22 that interprets a processing request from any of the applications 40 to 44 and 46 and issues a hardware-resource acquisition request along with an operating system (OS) 11. The platform layer 20 further includes a system resource managing unit (SRM) 24 that manages one or more hardware resources, and mediates an acquisition request from the control service layer 22 and control the execution of the request.

As the above-mentioned OS 11, for example, UNIX™ can be adopted; however, this does not prevent Windows™ or any other OS from being adopted. The software components of the controller unit 12 are implemented on the OS such as UNIX™ in parallel by process. Furthermore, the OS 11 includes a device driver for using various devices connected to an application specific integrated circuit (ASIC) to be described later.

The control service layer 22 includes various control services; in the embodiment shown in FIG. 2, as the control services, an NCS 50, a BCS 51, a DCS 52, an OCS 54, an FCS 56, an ECS 58, an MCS 60, and an SCS 64 are included in the control service layer 22. NCS stands for network control service; BCS stands for browser control service; DCS stands for delivery control service; OCS stands for operation panel control service; FCS stands for facsimile control service; ECS stands for engine panel control service; MCS stands for memory panel control service; and SCS stands for system panel control service.

The SCS 64 performs the management of various applications, the display of a system screen, the display of an LED, the management of hardware resources, the control of interrupt applications, etc. A UCS 62 manages user information. The MCS 60 performs the memory control, such as the acquisition and release of an image memory and the compression/decompression of image data. The ECS 58 controls engines, such as the black-and-white laser printer 32, the color laser printer 34, and the scanner, and performs an image reading process and an image forming process.

The FCS 56 is connected to a general switched telephone network (GSTN), and controls the sending and receiving of a facsimile using the GSTN, the registration/citation of various facsimile data managed by a backup memory, the reading of a facsimile, etc. The OCS 54 controls an operation panel that is an interface between an operator and main body control. The DCS 52 controls the delivery of an accumulated document accumulated in an HDD or the like. HDD is an abbreviation for Hard Disk Drive.

The NCS 50 controls a network interface card (NIC), and connects the image forming apparatus 10 to an Ethernet™ to provide a shared service to an application that requires a network I/O. More specifically, the NCS 50 sorts data that protocols have received from the network side into applications, and mediates the transmission of data from each application to the network side. For example, the NCS 50 controls the data communication with a network device connected via a network by a Hypertext Transport Protocol (HTTP) based on httpd (Hypertext Transfer Protocol Daemon).

The controller unit 12 further includes an application program interface (API) 78 between the platform layer 20 and the application layer 18. The platform layer 20 receives processing requests from the applications 40 to 48 that are expressed by predefined functions included in the API 78.

The SRM 24 performs the system control and the management of hardware resources along with the SCS 64. The SRM 24 determines whether a hardware resource requested to acquire is available or not, and, if it is available, notifies an upper layer that the hardware resource requested to acquire is available. Furthermore, in response to the acquisition request from the upper layer, the SRM 24 performs scheduling for using the hardware resource, and directly performs, for example, the allocation of the black-and-white laser printer 32 or the color laser printer 34, the memory allocation, the generation of a file, or the like.

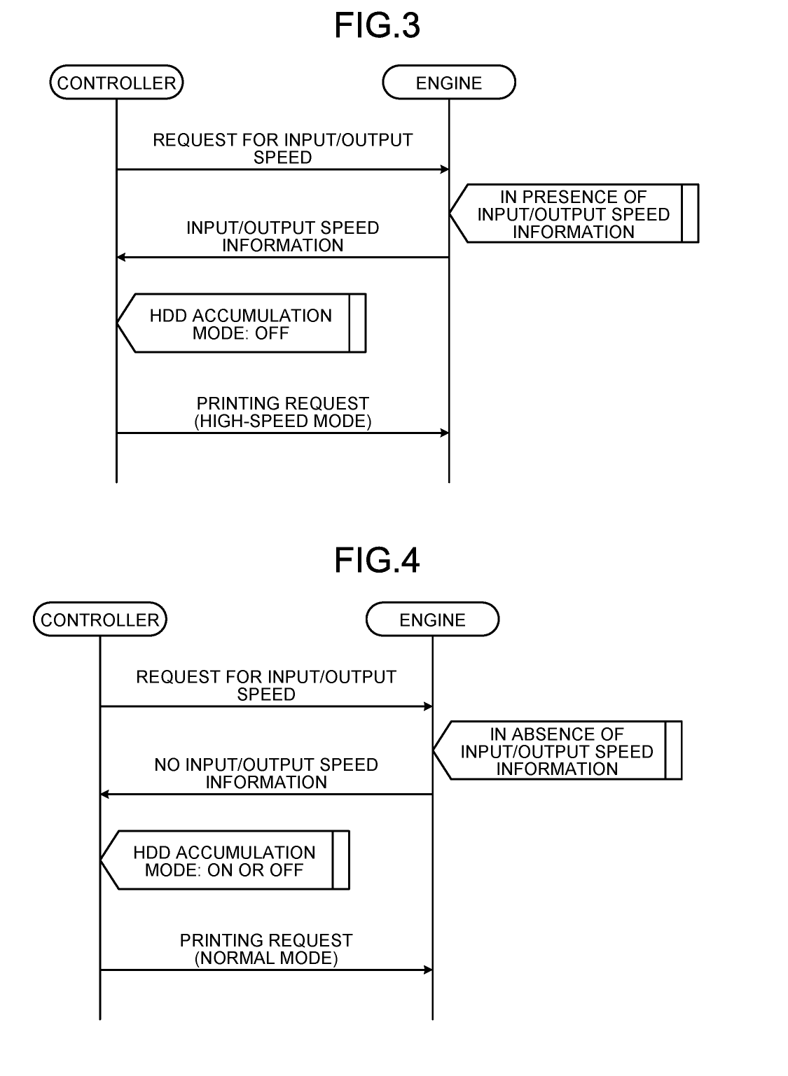

FIG. 3 is an explanatory diagram explaining about a request for printing in high-speed mode determined as printing mode in a process performed by controller software and engine software of the concrete image forming apparatus. The printing mode includes normal mode and high-speed mode. When a user makes a copy using a multifunction peripheral for office use, in the normal printing mode, the multifunction peripheral temporarily stores a scanned image in an HDD for sake of jam recovery; however, if a user wants high-speed printing, the high-speed printing mode is realized by turning the HDD accumulation mode off.

FIG. 3 illustrates a sequence diagram of the process performed by the controller software and the engine software of the image forming apparatus. First, when printing is performed by the image forming apparatus, the controller software instructs the engine software to issue a request for input/output speed information to the sensor that detects the reading speed and the printing speed. Then, if there is information of the input/output speed, the engine software sends the controller software the input/output speed information as a response to the request. And then, the controller software obtains the input/output speed information from the engine software, and, if the HDD accumulation mode of the image forming apparatus is off, the controller software issues a request for printing in the high-speed mode to the engine software.

FIG. 4 is an explanatory diagram explaining about a request for printing in the normal mode in which the printing speed is determined in a process performed by the controller software and the engine software of the concrete image forming apparatus. FIG. 4 illustrates a sequence diagram of the process performed by the controller software and the engine software of the image forming apparatus. First, when printing is performed by the image forming apparatus, the controller software instructs the engine software to issue a request for information of the reading speed and the printing speed to the reading-speed/printing-speed sensor. Then, if there is no information of the reading speed and the printing speed, the engine software sends the controller software a response indicating that there is no input/output speed information. And then, the controller software receives the response from the engine software; when the controller software has not obtained input/output speed information, regardless whether the HDD accumulation mode of the image forming apparatus is on or off, the controller software issues a request for printing in the normal mode to the engine software.

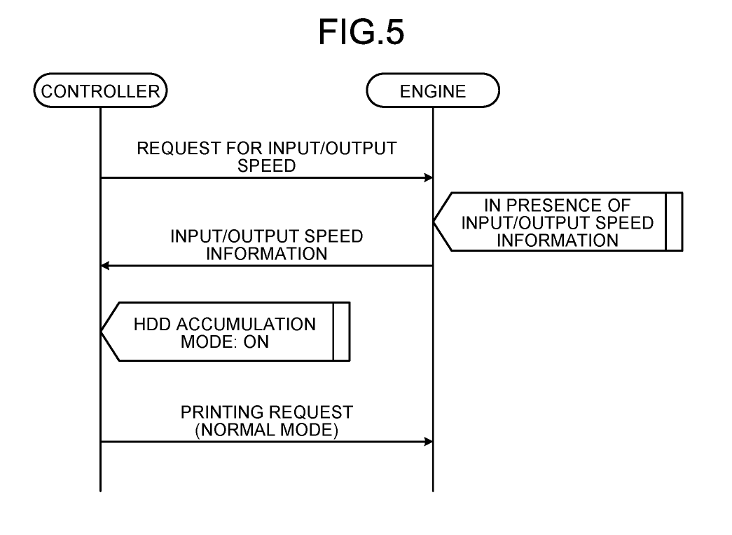

FIG. 5 is an explanatory diagram explaining about a request for printing in the normal mode determined as printing mode in a process performed by the controller software and the engine software of the concrete image forming apparatus. FIG. 5 illustrates a sequence diagram of the process performed by the controller software and the engine software of the image forming apparatus. First, when printing is performed by the image forming apparatus, the controller software instructs the engine software to issue a request for input/output speed information to the sensor. Then, if there is information of the input/output speed, the engine software sends the controller software the input/output speed information as a response to the request. And then, the controller software obtains the input/output speed information from the engine software, and, if the HDD accumulation mode of the image forming apparatus is on, the controller software issues a request for printing in the normal mode to the engine software.

Incidentally, if there is no sensor that measures the reading speed and the printing speed, it is preferable to print in a condition of reading in the normal mode.

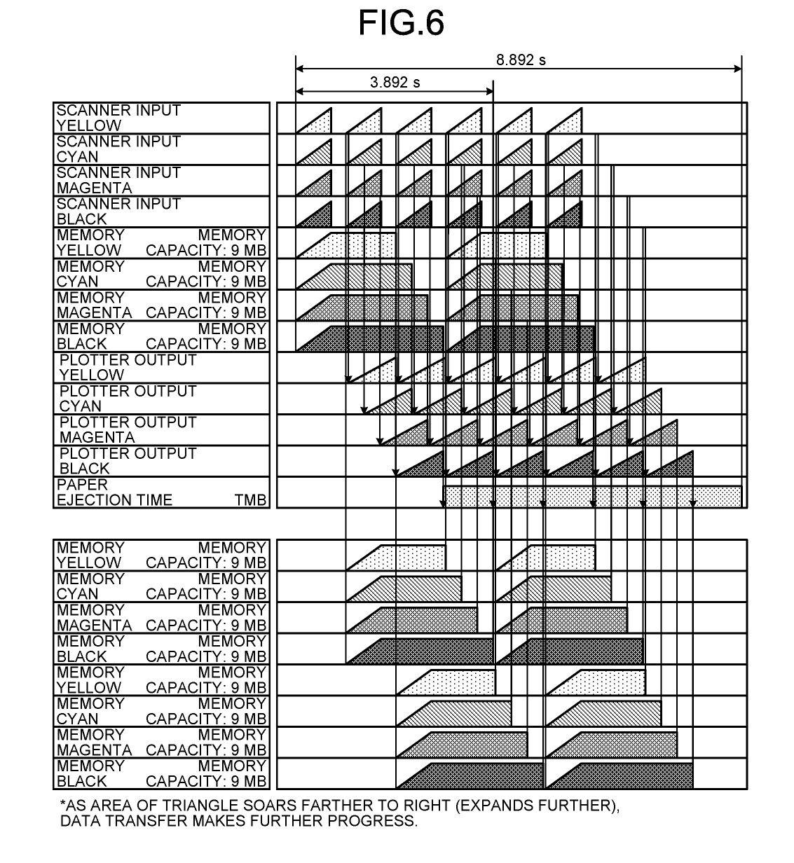

FIG. 6 is an explanatory diagram explaining about an operating time of each resource in a printing operation using only the primary storage device without using a secondary storage device in synchronization with the input/output timing as this system of the concrete image forming apparatus. FIG. 6 illustrates a timing chart showing an operating time of each resource in a printing process performed by the image forming apparatus. A triangle denotes data for one page of a document. As the area of a triangle soars farther to the right (expands further), the data transfer makes further progress. A right trapezoid indicates that data is held and then deleted upon completion of printing.

Here, rows of Plotter Output Yellow to Black and a row of Paper Ejection Time are depicted in the middle of the drawing; this is because to make it easy to read. Incidentally, in the case of a color printer, four input planes, four memory planes, and four output planes are the minimum configuration, and a paper ejection time corresponds to the minimum configuration. An additional memory is not essential as basic operation, and is of low importance. If a memory is to be added, there are points at which memories operate timely, respectively; how much more are memories to be added differs according to configuration.

In all the rows of Memory and Scanner Input in each timing chart, the bases of right triangles of Yellow, Cyan, Magenta, and Black scanner inputs have the same length. On the other hand, a relationship of the lengths of the bases of right triangles satisfies Yellow<Cyan<Magenta<Black, this is because data of a scanned document is held until the data has been printed.

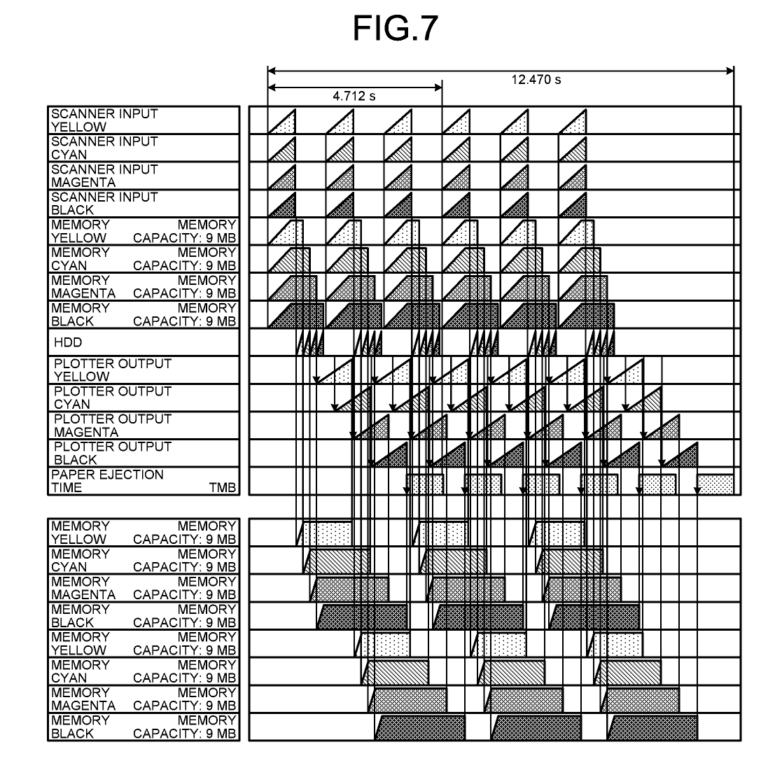

The printing speed and the memory usage are compared with those in FIGS. 7 to 9.

FIG. 7 is an explanatory diagram explaining about an operating time of each resource in a printing operation in which data is stored in an HDD in synchronization with the input/output timing of the concrete image forming apparatus. FIG. 7 illustrates a timing chart showing an operating time of each resource in the printing process performed by the image forming apparatus. Since it takes extra time to accumulate data in the HDD, the printing completion time is later than that in FIG. 6.

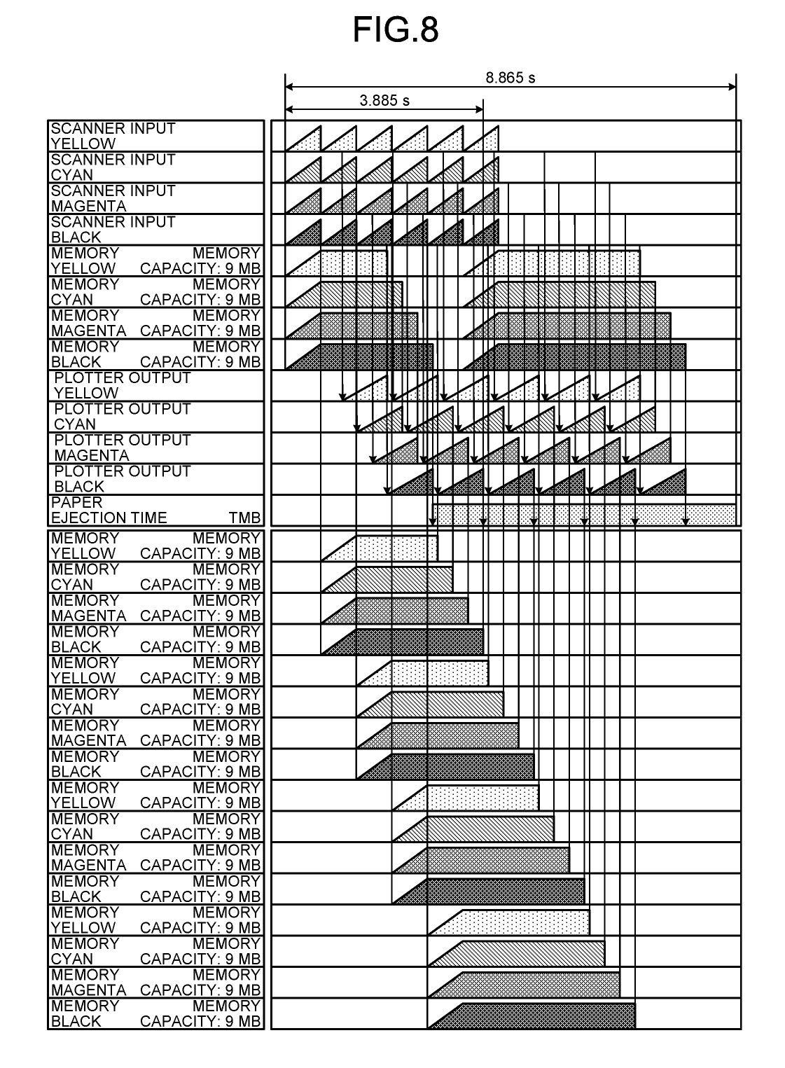

FIG. 8 is an explanatory diagram explaining about an operating time of each resource in a printing operation using only the primary storage device without the synchronization with the input/output timing of the concrete image forming apparatus. FIG. 8 illustrates a timing chart showing an operating time of each resource in the printing process performed by the image forming apparatus. When an input precedes, an image has to be held in a memory until an output is completed; therefore, the memory usage increases.

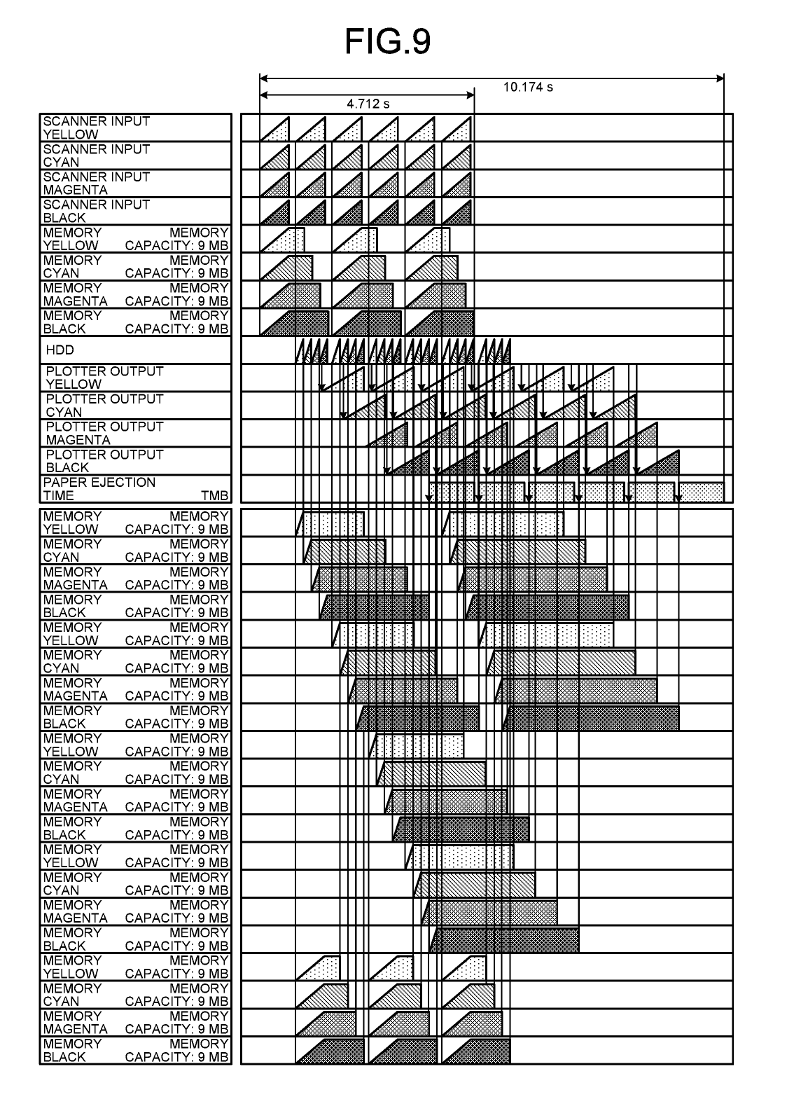

FIG. 9 is an explanatory diagram explaining about an operating time of each resource in a printing operation using both the primary storage device and the secondary storage device without the synchronization with the input/output timing of the concrete image forming apparatus. FIG. 9 illustrates a timing chart showing an operating time of each resource in the printing process performed by the image forming apparatus. When an input precedes, an image has to be held in a memory until an output is completed; therefore, the memory usage increases (To give priority to the printing speed, a process of “releasing memory and again acquiring memory from the HDD when needed” is omitted). Since it takes extra time to accumulate data in the HDD, the printing completion time is later than that in FIG. 6.

### Program

The above-described image forming apparatus according to the present invention is realized by a program causing a computer to execute processes. As an example, there is described the case where the functions of the present invention are realized by a program.

For example, there is a computer-readable program that causes a computer of an image forming apparatus to execute the following processes: causing a reading device to read a document; temporarily storing image data of the read document in a primary storage device; causing a printing device to print the temporarily-stored image data; and causing a control device to set the printing speed and synchronize the reading speed of the reading device with the printing speed of the printing device so that a waiting time is minimized. Such a program can be stored in a computer-readable storage medium.

### Storage Medium

Examples of the storage medium include a computer-readable storage media such as a CD-ROM, an FD, and a CD-R, semiconductor memories such as a flash memory, a RAM, a ROM, and an FeRAM, and an HDD.

CD-ROM is an abbreviation for Compact Disc Read Only Memory. FD is an abbreviation for Flexible Disk. CD-R is an abbreviation for CD Recordable. RAM is an abbreviation for Random-Access Memory. ROM is an abbreviation for Read-Only Memory. FeRAM is an abbreviation for Ferroelectric RAM, and denotes a ferroelectric memory.

According to the present invention, it is possible to achieve high printing speed with low memory consumption even in the printing of a multi-page document.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image forming apparatus comprising:
a reading device configured to read a document;
a primary storage device configured to temporarily store therein image data of the read document;
a printing device configured to print the temporarily-stored image data; and
a control device configured to set a printing speed and to synchronize a reading speed of the reading device with the printing speed of the printing device so that a waiting time is minimized.

2. The image forming apparatus according to claim 1, wherein the reading device and the printing device perform reading and printing at a reading speed and a printing speed according to the predetermined reading speed and printing speed transmitted from the control device.

3. The image forming apparatus according to claim 1, wherein
the control device includes a sensor that detects a reading speed at which a document is read and a printing speed at which the printing device prints image data of the document, and
the sensor transmits the reading speed and the printing speed to the control device, the control device corrects the reading speed and the printing speed, and the printing device prints image data at the corrected printing speed.

4. The image forming apparatus according to claim 1, wherein the control device corrects the reading speed and the printing speed according to the reading speed and printing speed measured by a sensor.

5. The image forming apparatus according to claim 1, wherein the control device is further configured to be capable of:
fixing the reading speed and the printing speed;
setting the reading speed and the printing speed on a page-by-page basis by reading control/printing control; and
setting the reading speed and the printing speed on a page-by-page basis based on the reading speed and printing speed measured by a sensor.

6. The image forming apparatus according to claim 1, wherein the control device is further configured to be capable of fixing a condition of the optimum reading speed and the optimum printing speed and locking a setting button on an operation device so as to be kept unchanged.

7. An image forming system comprising:
a document reader configured to read a document;
a memory configured to temporarily store therein image data of the read document;
a printer configured to print the temporarily-stored image data; and
a controller configured to set a printing speed and to synchronize a reading speed of the reading device with the printing speed of the printing device so that a waiting time is minimized.

8. An image forming method comprising:
setting a printing speed when image data of a read document is temporarily stored and then printed; and
synchronizing a reading speed of a reading device with the printing speed of a printing device so that a waiting time is minimized.
